(19) United States
(12) Patent Application Publication
(10) Pub. No.: US 2022/0279234 A1
(43) Pub. Date: Sep. 1, 2022

(54) LIVE STREAM DISPLAY METHOD AND APPARATUS, ELECTRONIC DEVICE, AND READABLE STORAGE MEDIUM

(71) Applicant: GUANGZHOU HUYA TECHNOLOGY CO., LTD., Guangzhou (CN)

(72) Inventor: Junqi QIU, Guangzhou (CN)

(21) Appl. No.: 17/630,187

(22) PCT Filed: Nov. 6, 2020
(86) PCT No.: PCT/CN2020/127052

§ 371 Date: Jan. 26, 2022

(30) Foreign Application Priority Data
Nov. 7, 2019 (CN) 201911080033.0
Nov. 7, 2019 (CN) 201911080059.5
Nov. 7, 2019 (CN) 201911080076.9

(51) Int. Cl. H04N 21/431; H04N 21/2187; H04N 21/81; G06T 19/00

(52) U.S. Cl. CPC H04N 21/4312; H04N 21/2187; H04N 21/816; G06T 19/006

(57) ABSTRACT

A live stream display method and apparatus, an electronic device, and a readable storage medium are provided. The method comprises: upon detecting an augmented reality (AR) display instruction, entering an AR recognition plane, and generating a corresponding target model object in the AR recognition plane; and rendering a received live stream onto the target model object, so as to display the live stream on the target model object.

### CROSS-REFERENCE TO RELATED APPLICATION

The present disclosure claims the priority to the Chinese patent application filed with the Chinese Patent Office on Nov. 7, 2019 with the filing No. 2019110800769, and entitled “Barrage Display Method and Apparatus, Electronic Device and Readable Storage Medium”, the priority to the Chinese patent application filed with the Chinese Patent Office on Nov. 7, 2019 with the filing No. 2019110800595, and entitled “Live Broadcast Data Processing Method and Apparatus, Electronic Device and Readable Storage Medium”, and the priority to the Chinese patent application filed with the Chinese Patent Office on Nov. 7, 2019 with the filing No. 2019110800330, and entitled “Live Stream Display Method and Apparatus, Electronic Device and Readable Storage Medium”, all the contents of which are incorporated herein by reference in entirety.

### TECHNICAL FIELD

The present disclosure relates to the technical field of Internet live streaming, and in particular, to a live stream display method and apparatus, an electronic device, and a readable storage medium.

### BACKGROUND ART

Augmented Reality (AR) is a technology for calculating a position and angle of a camera image in real time and adding a corresponding image, and this technology aims at putting a virtual world, which is on the screen, in the real world and interacting. The augmented reality technology not only presents the information of the real world, but also displays the virtual information at the same time, and the two kinds of information is mutually supplemented and superposed, so that the real world and the computer graphics, in plurality, are synthesized together, then it can be seen that it is within the real world.

Although the application of the AR technology has been quite wide, the application of the AR technology in Internet live streaming is less, and the application of the Internet live streaming in the AR-rendered real-world scenarios is lacked, so that the live streaming is not so entertaining.

### SUMMARY

The present disclosure aims at providing a live stream display method and apparatus, an electronic device, and a readable storage medium, which can realize the application of Internet live stream in AR-rendered real-world scenarios and improve the live streaming playability.

In order to realize at least one of the above objectives, a technical solution adopted in the present disclosure is as follows.

An embodiment of the present disclosure provides a live stream display method, applied to a live streaming watching terminal, wherein the method includes:

upon detecting an AR display instruction, entering an AR recognition plane and generating a corresponding target model object in the AR recognition plane; and

rendering the received live stream onto the target model object, so as to display the live stream on the target model object.

An embodiment of the present disclosure further provides a live stream display apparatus, applied to a live streaming watching terminal, wherein the apparatus includes:

a generating module, configured to enter, upon detecting an AR display instruction, an AR recognition plane and generate a corresponding target model object in the AR recognition plane; and

a display module, configured to render the received live stream onto the target model object, so as to display the live stream on the target model object.

An embodiment of the present disclosure further provides an electronic device, wherein the electronic device includes a machine readable storage medium and a processor, the machine readable storage medium stores machine executable instructions, and when the processor executes the machine executable instructions, the electronic device realizes the above live stream display method.

An embodiment of the present disclosure further provides a readable storage medium, wherein the readable storage medium stores machine executable instructions, and when the machine executable instructions are executed, the above live stream display method is realized.

### BRIEF DESCRIPTION OF DRAWINGS

FIG. 1 shows a schematic view of an interaction scenario of a live streaming system 10 provided in an embodiment of the present disclosure;

FIG. 2 shows a schematic flowchart of a live stream display method provided in an embodiment of the present disclosure;

FIG. 3 shows a schematic flowchart of sub-steps of Step 110 shown in FIG. 2;

FIG. 4 shows a schematic flowchart of sub-steps of Step 120 shown in FIG. 2;

FIG. 5 shows a schematic view of not displaying a live stream on a target model object provided in an embodiment of the present disclosure;

FIG. 6 shows a schematic view of displaying a live stream on the target model object provided in an embodiment of the present disclosure;

FIG. 7 shows another schematic flowchart of the live stream display method provided in an embodiment of the present disclosure;

FIG. 8 shows a further schematic flowchart of the live stream display method provided in an embodiment of the present disclosure;

FIG. 9 shows a further schematic flowchart of the live stream display method provided in an embodiment of the present disclosure;

FIG. 10 shows a schematic flowchart of sub-steps of Step 180 shown in FIG. 9;

FIG. 11 shows a schematic flowchart of sub-steps of Step 183 shown in FIG. 10;

FIG. 12 shows a schematic view of displaying barrages on a live stream in a solution provided in an embodiment of the present disclosure;

FIG. 13 shows a schematic view of displaying barrages on an AR recognition plane in a solution provided in an embodiment of the present disclosure;

FIG. 14 shows a schematic view of functional modules of a live stream display apparatus provided in an embodiment of the present disclosure; and

FIG. 15 shows a structural schematic block diagram of an electronic device configured to implement the above live stream display method provided in an embodiment of the present disclosure.

### DETAILED DESCRIPTION OF EMBODIMENTS

In order to make objectives, technical solutions, and technical effects of the embodiments of the present disclosure clearer, the technical solutions in the embodiments of the present disclosure will be described clearly and completely below in conjunction with accompanying drawings in the embodiments of the present disclosure. It should be understood that the accompanying drawings in the present disclosure are merely for the illustrative and descriptive purpose, rather than limiting the scope of protection of the present disclosure. Besides, it should be understood that the schematic drawings are not drawn to scale. The flowcharts used in the present disclosure show operations implemented according to some of the embodiments of the present disclosure. It should be understood that the operations of the flowcharts may be implemented out of order, and steps without logical context may be reversed in order or simultaneously implemented. In addition, one skilled in the art, under the guidance of the present disclosure, may add one or more other operations to the flowcharts, or remove one or more operations from the flowcharts.

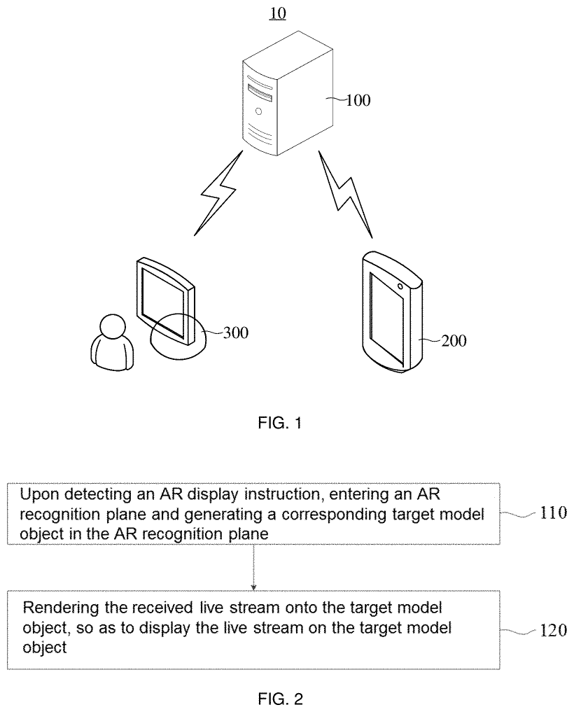

Referring to FIG. 1, FIG. 1 shows a schematic view of an interaction scenario of a live streaming system 10 provided in an embodiment of the present disclosure. In some embodiments, the live streaming system 10 may be configured as a service platform for, e.g. Internet live streaming. The live streaming system 10 may include a live streaming server 100, a live streaming watching terminal 200, and a live streaming providing terminal 300. The live streaming server 100 may be in communication with the live streaming watching terminal 200 and the live streaming providing terminal 300, respectively, and the live streaming server 100 may be configured to provide a live streaming service for the live streaming watching terminal 200 and the live streaming providing terminal 300. For example, an anchor (compere) may provide a live stream online in real time to an audience through the live streaming providing terminal 300 and transmit the live stream to the live streaming server 100, and the live streaming watching terminal 200 may pull the live stream from the live streaming server 100 for online watching or playback.

In some implementation scenarios, the live streaming watching terminal 200 and the live streaming providing terminal 300 may be interchangeably used. For example, the anchor of the live streaming providing terminal 300 may use the live streaming providing terminal 300 to provide the live video service to the audience, or view the live videos provided by other anchors as an audience. For another example, the audience of the live streaming watching terminal 200 also may use the live steaming watching terminal 200 to watch the live videos provided by anchors concerned about, or provide as an anchor the live video service to other audiences.

In some embodiments, the live streaming watching terminal 200 and the live streaming providing terminal 300 may include, but are not limited to, mobile device, tablet computer, laptop computer, or a combination of any two or more thereof. In some embodiments, the mobile device may include, but is not limited to, smart home device, wearable device, smart mobile device, augmented reality device, etc., or any combination thereof. In some embodiments, the smart home device may include, but is not limited to, smart lighting device, control device of smart electrical equipment, smart monitoring device, smart television, smart camera, intercom, etc., or any combination thereof. In some embodiments, the wearable device may include, but is not limited to, smart wristband, smart shoelaces, smart glass, smart helmet, smart watch, smart garment, smart backpack, smart accessory, etc., or any combination thereof. In some embodiments, the smart mobile device may include, but is not limited to, smart phone, Personal Digital Assistant (PDA), gaming device, navigation device, or point of sale (POS) device, etc., or any combination thereof.

In some embodiments, there may be zero, one or more live streaming watching terminals 200 and live streaming providing terminals 300 accessing the live streaming server 100, and only one live streaming watching terminal and one live streaming providing terminal are shown in FIG. 1. In the above, the live streaming watching terminal 200 and the live streaming providing terminal 300 may be installed with an Internet product configured to provide Internet live streaming service, for example, the Internet product may be an application APP, a Web webpage, or an Applet used in a computer or a smart phone and related to the Internet live streaming service.

In some embodiments, the live streaming server 100 may be a single physical server, or a server group composed of a plurality of physical servers configured to perform different data processing functions. The server group may be centralized or distributed (for example, the live streaming server 100 may be a distributed system). In some possible embodiments, if the live streaming server 100 is a single physical server, the live streaming server 100 may allocate different logical server components to the physical server based on different live streaming service functions.

It can be understood that the live streaming system 10 shown in FIG. 1 is only a feasible example, and in other feasible embodiments, the live streaming system 10 may also include only a part of the components shown in FIG. 1 or may also include other components.

In order to enable the application of the Internet live stream in the AR-rendered real-world scenario, and improve the live streaming playability, so as to effectively improve the user retention rate, FIG. 2 shows a schematic flowchart of a live stream display method provided in an embodiment of the present disclosure. In some embodiments, the live stream display method may be executed by the live streaming watching terminal 200 shown in FIG. 1, or when the anchor of the live streaming providing terminal 300 acts as an audience, the live stream display method may also be executed by the live streaming providing terminal 300 shown in FIG. 1.

It should be understood that in some other implementations of the embodiments of the present disclosure, the order of some steps in the live stream display method provided in the embodiments of the present disclosure may be exchanged with each other according to actual needs, or some steps thereof may be omitted or deleted. Hereinafter, various steps in the live stream display method provided in the embodiments of the present disclosure are exemplarily described.

Step 110, upon detecting an AR display instruction, entering an AR recognition plane and generating a corresponding target model object in the AR recognition plane.

Step 120, rendering the received live stream onto the target model object, so as to display the live stream on the target model object.

In some embodiments, for Step 110, when the audience of the live streaming watching terminal 200 logs in to a live streaming room that needs to be watched, the audience may input a control instruction on a display interface of the live streaming watching terminal 200, so as to select to display the live streaming room in an AR manner, or the live streaming watching terminal 200 may automatically display the live streaming room in an AR manner when entering the live streaming room, so that the AR display instruction may be triggered.

When the live streaming watching terminal 200 detects the AR display instruction, the live streaming watching terminal 200 may turn on a camera to enter the AR recognition plane, and then generate a corresponding target model object in the AR recognition plane.

When the target model object is displayed in the AR recognition plane, the live streaming watching terminal 200 may render the received live stream onto the target model object, so that the live stream is displayed on the target model object. In this way, the application of the Internet live stream in the AR-rendered real-world scenario can be realized, and the audience can watch the Internet live stream on the target model object rendered in the real-world scenario, thereby improving the live streaming playability, and effectively improving the user retention rate.

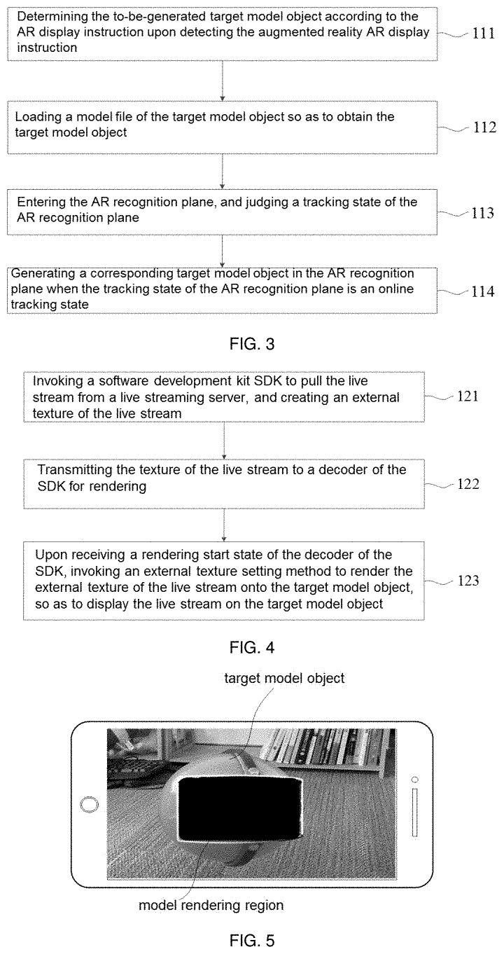

In a possible embodiment, for Step 110, after entering the AR recognition plane, in order to improve the stability of the AR display, and avoid the situation that an abnormality exists in the AR recognition plane to cause display error in the target model object, on the basis of FIG. 2, referring to FIG. 3, Step 110 may be implemented by the following sub-steps:

Step 111, determining the to-be-generated target model object according to the AR display instruction upon detecting the AR display instruction.

Step 112, loading a model file of the target model object so as to obtain the target model object.

Step 113, entering the AR recognition plane, and judging a tracking state of the AR recognition plane.

Step 114, generating a corresponding target model object in the AR recognition plane when the tracking state of the AR recognition plane is an online tracking state.

In some embodiments, after entering the AR recognition plane, the live streaming watching terminal 200 may judge the tracking state of the AR recognition plane. For example, after entering the AR recognition plane, the live streaming watching terminal 200 may register addOnUpdateListener monitoring, and then obtain the currently identified AR recognition plane through, for example, arFragment.getArSceneView( )getSession( )getAllTrackables(Plane.class) in the monitoring method, and when the tracking state of the AR recognition plane is the online tracking state TrackingState.TRACKING, it means that the AR recognition plane can be displayed normally, then the live streaming watching terminal 200 can generate the corresponding target model object in the AR recognition plane.

In this way, by identifying the tracking state of the AR recognition plane when entering the AR recognition plane, and then executing the next operation, the stability of the AR display can be improved, and the situation that an abnormality occurs in the AR recognition plane to cause a display error in the target model object can be avoided.

In the above, in some embodiments, for Step 111, the target model object may refer to a three-dimensional AR model configured to be displayed in the AR recognition plane, the target model object may be selected in advance by the audience, or may be selected by default by the live streaming watching terminal 200, or a suitable three-dimensional AR model is dynamically selected according to a real-time scenario captured after starting a camera, which is not limited in the embodiments of the present disclosure.

Thus, the live streaming watching terminal 200 may determine the to-be-generated target model object from the AR display instruction. For example, the target model object may be a television set with a display screen, a notebook computer, a spliced screen, a projection screen, and the like, which is not specifically limited in the embodiments of the present disclosure.

In addition, for Step 112, in some possible scenarios, the model object is generally not stored in a file of standard format, but is stored in a format specified by an AR software development kit program; therefore, in order to facilitate loading and format conversion of a model object, the embodiments of the present disclosure can use a preset model import plug-in to import a three-dimensional model of the target model object, to obtain an sfb format file corresponding to the target model object, and then obtaining the target model object by loading the sfb format file through a preset rendering model.

For example, as a possible embodiment, taking the AR software development kit program being ARCore as an example, the live streaming watching terminal 200 may use the google-sceneform-tools plug-in to import an FBX 3D model of the target model object, to obtain the sfb format file corresponding to the target model object, and then load the sfb format file through the ModelRenderable model to obtain the target model object.

For Step 113, in a possible embodiment, in the process of generating the corresponding target model object in the AR recognition plane, in order to ensure that the target model object does not change with the movement of the camera subsequently in the AR recognition plane, and facilitate that the target model object can be adjusted by the user's operation, the generating process of the target model object is described below with reference to a possible example.

First, the live streaming watching terminal 200 may create an anchor point Anchor on a preset point of the AR recognition plane, so as to fix the target model object on the preset point through the anchor point Anchor.

Next, the live streaming watching terminal 200 creates a corresponding display node AnchorNode at the position of the anchor point Anchor, and creates a first child node TransformableNode inherited to the display node AnchorNode, so as to adjust and display the target model object through the first child node TransformableNode.

For example, the manner of adjusting the target model object through the first child node TransformableNode may include one or a combination of more of the following adjustment manners:

1) Scaling the target model object. For example, the target model object may be adjusted by scaling (scaling down or enlarging) in entirety, or a part of the target model object also may be adjusted by scaling.

2) Translating the target model object. For example, the target model object may be moved along various directions (leftwards, rightwards, upwards, downwards, obliquely) by a preset distance.

3) Rotating the target model object. For example, the target model object may be rotated in a clockwise or counterclockwise direction.

For another example, the live streaming watching terminal 200 may invoke a binding setting method of the first child node TransformableNode, and bind the target model object to the first child node TransformableNode, so as to complete the display of the target model object in the AR recognition plane.

Next, the live streaming watching terminal 200 may create a second child node Node inherited to the first child node TransformableNode, so that the second child node Node can be replaced by a skeleton adjustment node SkeletonNode upon detecting an adding request of the skeleton adjustment node SkeletonNode, wherein the target model object may generally include a plurality of skeleton points, and the skeleton adjustment node SkeletonNode may be configured to adjust the skeleton points of the target model object.

Thus, during the process of generating the corresponding target model object in the AR recognition plane, the target model object is fixed on the preset point by the anchor point, ensuring that the target model object does not change with the movement of the camera subsequently in the AR recognition plane; furthermore, by adjusting and displaying the target model object through the first child node, it is facilitated that the target model object can be adjusted by the user's operation and displayed in real time. It is also considered that the skeleton adjustment node may be added to perform skeleton adjustment on the target model object, the second child node inherited to the first child node may be reserved, and in this way, it is facilitated that the second child node may be replaced by the skeleton adjustment node when the skeleton adjustment node is added subsequently.

Based on the foregoing description, in a possible embodiment, for Step 120, in order to improve the real-world scenario experience after the live stream is rendered onto the target model object, Step 120 is exemplarily described below with reference to a possible embodiment shown in FIG. 4. Referring to FIG. 4, Step 120 may be implemented in a following manner.

Step 121, invoking a software development kit SDK to pull the live stream from a live streaming server, and creating an external texture of the live stream.

Step 122, transmitting the texture of the live stream to a decoder of the SDK for rendering.

Step 123, upon receiving a rendering start state of the decoder of the SDK, invoking an external texture setting method to render the external texture of the live stream onto the target model object, so as to display the live stream on the target model object.

In some embodiments, taking the live streaming watching terminal 200 running on an Android system as an example, the software development kit may be hySDK, that is, the live streaming watching terminal 200 may pull the live stream from the live streaming server 100 through the hySDK, and create an external texture ExternalTexture of the live stream, and then transmit the ExternalTexture to the decoder of the hySDK for rendering. In this process, the decoder of the hySDK may perform 3D rendering for the ExternalTexture, and at this time, the rendering start state is entered, in this way, the external texture setting method setExternalTexture may be invoked to render the ExternalTexture onto the target model object, so as to display the live stream on the target model object.

For example, there may be generally a plurality of regions on the target model object, some regions may only be configured for model display, and some regions may be configured to display related video streams or other information. Based on this, the live streaming watching terminal 200 may traverse each region in the target model object, determine at least one model rendering region in the target model object that can be used for rendering the live stream, and then invoke an external texture setting method to render the external texture of the live stream onto the at least one model rendering region.

Optionally, in some embodiments, the audience may determine through the live streaming watching terminal 200 contents that can be displayed in each model rendering region, for example, if the target model object includes a model rendering region A and a model rendering region B, the model rendering region A may be selected to display the live stream, and the model rendering region B may be selected to display specific picture information or specific video information configured by the audience.

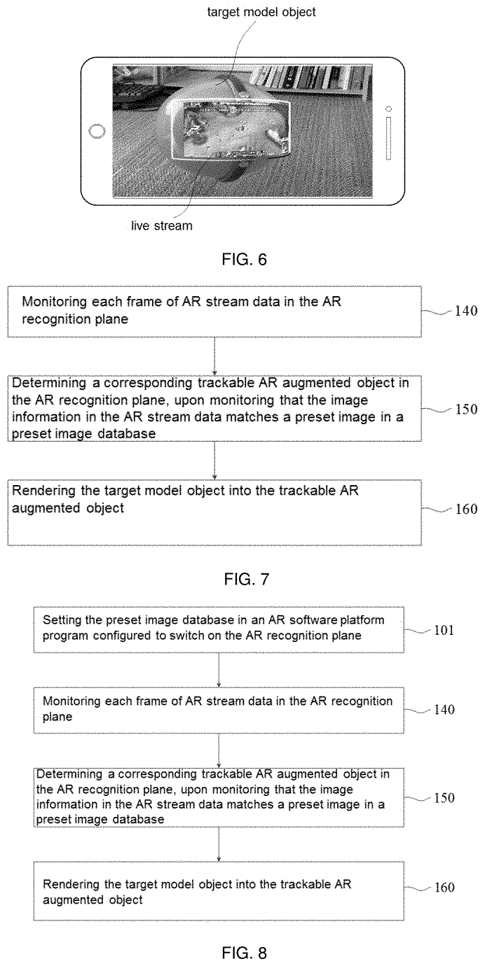

In order to facilitate illustration of the scenario of the embodiment of the present disclosure, the target model object is illustrated below with reference to FIG. 5 and FIG. 6, and schematic views of not displaying the live stream on the target model object and displaying the live stream on the target model object are respectively provided for brief illustration.

Referring to FIG. 5, a schematic view of an interface of an exemplary AR recognition plane entered by a live streaming watching terminal 200 after turning on a camera is shown, wherein the target model object shown in FIG. 5 may be adaptively set in a certain position in a real-world scenario, for example, in a middle position, and in this case, no related live stream is displayed on the target model object, and only one model rendering region is displayed to the audience.

Referring to FIG. 6, another schematic view of an interface of an exemplary AR recognition plane entered by the live streaming watching terminal 200 after turning on a camera is shown, wherein when the live streaming watching terminal 200 receives the live stream, the live stream can be rendered according to the foregoing embodiments onto the target model object in the foregoing FIG. 5 for display, and in this case, it can be seen that the live stream has been rendered into the model rendering region shown in FIG. 5.

Thus, for the audience, he/she can watch the Internet live stream on the target model object rendered in the real-world scenario, then the live streaming playability is improved, so as to effectively improve the user retention rate.

Besides, for example, for the above scenarios such as the Internet live streaming, in order to realize the display of barrages in the AR-rendered real-world scenario and improve the live streaming playability, so as to effectively improve the user retention rate, FIG. 7 shows another schematic flowchart of the live stream display method provided in an embodiment of the present disclosure. In some embodiments, the live stream display method further may include the following steps.

Step 140, monitoring each frame of AR stream data in the AR recognition plane.

Step 150, determining a corresponding trackable AR augmented object in the AR recognition plane, upon monitoring that the image information in the AR stream data matches a preset image in a preset image database.

Step 160, rendering the target model object into the trackable AR augmented object.

In some embodiments, after switching on the AR recognition plane by using the above solution provided in the embodiment of the present disclosure, the live streaming watching terminal 200 may monitor each frame of AR stream data in the AR recognition plane, and upon monitoring that the image information in the AR stream data matches the preset image in the preset image database, the live streaming watching terminal 200 may determine a corresponding trackable AR augmented object in the AR recognition plane; then the target model object rendered and obtained by using the above embodiments is rendered into the trackable AR augmented object. In this way, the application of the trackable AR augmented object in the live stream can be realized, so that the interaction between the audience and the anchor is closer to the real-world scenario experience, so as to improve the user retention rate.

In a possible embodiment, the above preset image database may be preset and subjected to AR association, so that an image matching operation may be performed when monitoring each frame of AR stream data. For example, referring to FIG. 8, before executing Step 140, the live streaming watching terminal 200 further may execute the following step:

Step 101, setting the preset image database in an AR software platform program configured to switch on the AR recognition plane.

In some embodiments, taking the Android system as an example, the AR software platform program may be, but is not limited to, ARCore. By setting the preset image database in the AR software platform program configured to switch on the AR recognition plane, when the AR software platform program switches on the AR recognition plane, the live streaming watching terminal 200 can make the image information in the AR stream data matched with a preset image in the preset image database.

For example, taking the Android system as an example, generally, picture resources in the Android system are stored in assets directory, and on this basis, the live streaming watching terminal 200 may obtain the image resources to be identified from the live streaming server 100, and store the image resources in the assets directory; next, the live streaming watching terminal 200 may create the preset image database for the AR software platform program, for example, the preset image database for the AR software platform program may be created through Augmented Image Database; then, the live streaming watching terminal 200 may add the picture resources in the assets directory to the preset image database, so as to set the preset image database in the AR software platform program, and the AR software platform program may be configured to switch on the AR recognition plane, for example, the preset image database may be set in the AR software platform program through Config.set Augmented Image Database.

Exemplarily, in a possible embodiment, during the process after entering the AR recognition plane, in order to improve the stability of the monitoring process, and avoid the situation that an abnormality exists in the AR recognition plane to cause monitoring error, in the process of monitoring each frame of AR stream data in the switched-on AR recognition plane, the live streaming watching terminal 200 also may acquire an image capturing component Camera configured to capture image data from the AR stream data, and detect whether the tracking state of the image capturing component is an online tracking state TRACKING, and upon detecting that the tracking state of the image capturing component is the online tracking state TRACKING, the live streaming watching terminal 200 may monitor whether the image information in the AR stream data matches a preset image in the preset image database.

Correspondingly, after the corresponding trackable AR augmented object is determined in the AR recognition plane, in order to improve the stability in the process of subsequently rendering the target model object into the trackable AR augmented object, and avoid the situation of erroneous rendering, in some implementations provided in the embodiments of the present disclosure, the live streaming watching terminal 200 further may detect the tracking state of the trackable AR augmented object, and when it is detected that the tracking state of the trackable AR augmented object is the online tracking state TRACKING, the live streaming watching terminal 200 performs Step 160.

In addition, in some possible embodiments, for the above Step 160, in order to improve the degree of matching of the target model object in the trackable AR augmented object, the live streaming watching terminal 200 may acquire through a decoder first size information of the live stream rendered in the target model object, and acquire second size information of the trackable AR augmented object, and then adjust the above display node AnchorNode according to a proportional relationship between the first size information and the second size information, so as to adjust a proportion of the target model object in the trackable AR augmented object.

For example, the live streaming watching terminal 200 may allow the difference between the first size information and the second size information to be within a threshold range as much as possible by adjusting the proportion of the target model object in the trackable AR augmented object; in this way, the target model object may be enabled to substantially fill the entire trackable AR augmented object.

In addition, in order to facilitate the audience to perform personalized customization on the trackable AR augmented object, the trackable AR augmented object further may include some image features other than the target model object, for example, words, picture frames and like information added by the audience by inputting an instruction.

It is worth noting that, in some possible implementations of the embodiments of the present disclosure, in the process that the audience watches the live stream through the target model object displayed in the AR recognition plane, the live streaming watching terminal 200 also may obtain various to-be-played barrage data from the live streaming server 100, and render the barrage data into the AR recognition plane, so as to move the barrage data in the AR recognition plane, which, compared with some other solutions in which the barrage data is rendered into a live stream image to move, can improve the realistic effect when the barrages are played, and enhance the realistic experience of the barrage display. In this way, the display of the barrages in the AR-rendered real-world scenario is realized, and after switching on the camera, the audience can see the barrages moving in the AR-rendered real-world scenario, thereby improving the live streaming playability.

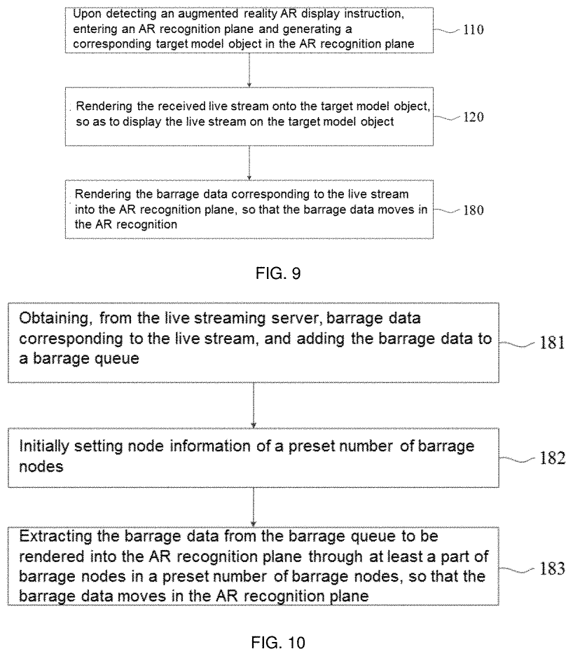

For example, in some of the implementations of the embodiments of the present disclosure, for realizing the display of the barrages in the AR-rendered real-world scenario in the above, and improving live streaming playability, on the basis of FIG. 2, referring to FIG. 9, FIG. 9 shows a further schematic flowchart of the live stream display method provided in an embodiment of the present disclosure, and the live stream display method further may include the following steps.

Step 180, rendering the barrage data corresponding to the live stream into the AR recognition plane, so that the barrage data moves in the AR recognition plane.

In some embodiments, when the audience watches the live stream through the target model object displayed in the AR recognition plane, the live streaming watching terminal 200 may obtain various to-be-played barrage data from the live streaming server 100, and render the barrage data into the AR recognition plane, so that the barrage data moves in the AR recognition plane, which, compared with some other live streaming schemes in which the barrage data is rendered into the live stream image to move, can improve the realistic effect when playing the barrages, and enhance the realistic experience of the barrage display. In this way, by means of the solution provided in the embodiments of the present disclosure, the display of the barrages in the AR-rendered real-world scenario can be realized, and after turning on the camera, the audience can see the barrages moving in the AR-rendered real-world scenario, thereby improving the live streaming playability.

Based on the above, in some possible embodiments, for Step 180, as the barrages usually may be released intensively, too much memory on the live streaming watching terminal 200 side is occupied, then the AR display process is unstable. Therefore, in order to improve the stability of the AR display process of the barrages, referring to FIG. 10, Step 180 may be implemented by the following steps.

Step 181: obtaining barrage data corresponding to the live stream from the live streaming server, and adding the barrage data to a barrage queue.

Step 182: initially setting node information of a preset number of barrage nodes.

Step 183, extracting the barrage data from the barrage queue to be rendered into the AR recognition plane through at least part of barrage nodes in a preset number of barrage nodes, so that the barrage data moves in the AR recognition plane.

In some implementations of the embodiments of the present disclosure, after the live streaming watching terminal 200 obtains from the live streaming server 100 the barrage data corresponding to the live stream, the live streaming watching terminal 200 may not directly render the barrage data into the AR recognition plane, but may first add the barrage data to the barrage queue. On this basis, the live streaming watching terminal 200 may set a certain number (for example, 60) of barrage nodes BarrageNode for the AR recognition plane, and a parent node of each barrage node BarrageNode may be the second child node created above, and each barrage node may be configured to display one barrage.

Then, in the process that the live streaming watching terminal 200 renders the barrage data into the AR recognition plane, the live streaming watching terminal 200 may render the barrage data into the AR recognition plane through at least a part of barrage nodes in the preset number of barrage nodes, so that the barrage data moves in the AR recognition plane; in this way, the number of barrage nodes can be determined according to the specific number of barrages, so as to avoid too much memory occupation due to the intensive release of the barrages and instability of AR display process, and improve the stability of the barrage AR display process.

For example, in some possible embodiments, for Step 181, the live streaming watching terminal 200 may judge whether the queue length of the barrage queue is greater than the barrage number of the barrage data, and when the queue length of the barrage queue is not greater than the number of barrages of the barrage data, the live streaming watching terminal 200 may add the barrage data to the barrage queue; when the queue length of the barrage queue is greater than the number of barrages of the barrage data, the live streaming watching terminal 200 may continue to add the barrage data to the barrage queue after expanding the length of the barrage queue by a preset length, each time the queue length of the barrage queue is greater than the number of barrages of the barrage data; and when the queue length of the expanded barrage queue is greater than a preset threshold, the live streaming watching terminal 200 may discard a set number of barrages from the barrage queue in the order from early barrage time to late barrage time.

For example, assuming that the preset threshold is 200, and the preset length of the live streaming watching terminal 200 expanded each time is 20, when the queue length of the barrage queue is not greater than the number of barrages of the barrage data, the live streaming watching terminal 200 may add the barrage data to the barrage queue; when the queue length of the barrage queue is greater than the number of barrages of the barrage data, the live streaming watching terminal 200 may continue to add the barrage data to the barrage queue after expanding the length of the barrage queue by 20; and when the queue length of the expanded barrage queue is greater than 200, the live streaming watching terminal 200 may discard 20 earliest barrages from the barrage queue in the order from early barrage time to late barrage time.

In some possible embodiments, for Step 182, the live streaming watching terminal 200 can set the display information of various barrage nodes in the AR recognition plane respectively after setting a preset number of barrage nodes with the second child node as parent node, and the display information can be configured to indicate how to display and move the corresponding barrages when these barrage nodes are set subsequently.

For example, in a possible example, the AR recognition plane may include an X axis, a Y axis and a Z axis with the second node as a coordinate central axis; in addition, world coordinates of each barrage node in the AR recognition plane may be set along different offset displacement points on the Y axis and the Z axis, so that various barrage nodes are arranged at intervals along the Y axis and the Z axis; in this way, the subsequent barrages may exhibit different senses of hierarchy and distance when performing AR display.

Furthermore, in some embodiments, a position, offset from a first direction of the parent node by a preset unit of displacement (for example, 1.5 units of displacement) on the X axis, also may be determined as a first position, and a position, offset from a second direction of the parent node by a preset unit of displacement (for example, 1.5 units of displacement) on the X axis, may be determined as a second position, and the first position is set as the world coordinate for each barrage node to start displaying, and the second position is set as the world coordinate for each barrage node to end displaying. In this way, it may be convenient to adjust a starting position and an ending position of the barrages.

Optionally, in some possible scenarios, the first direction above may be a left direction of the screen, and the second direction may be a right direction of the screen; alternatively, the first direction above may be the right direction of the screen, and the second direction may be the left direction of the screen; and alternatively, the first direction and the second direction also may be any other directions.

In a possible embodiment, when the number of barrages is insufficient, and when the barrage nodes are all in a use state, excess performance consumption may be increased. Based on this, the live streaming watching terminal 200 extracts barrage data from the barrage queue and renders the extracted barrage data into the AR recognition plane through at least a part of barrage nodes in the preset number of barrage nodes, so that before the barrage data moves in the AR recognition plane, the live streaming watching terminal 200 may set a preset number of barrage nodes to be in an inoperable state, and in the inoperable state, the barrage nodes do not participate in the barrage display process.

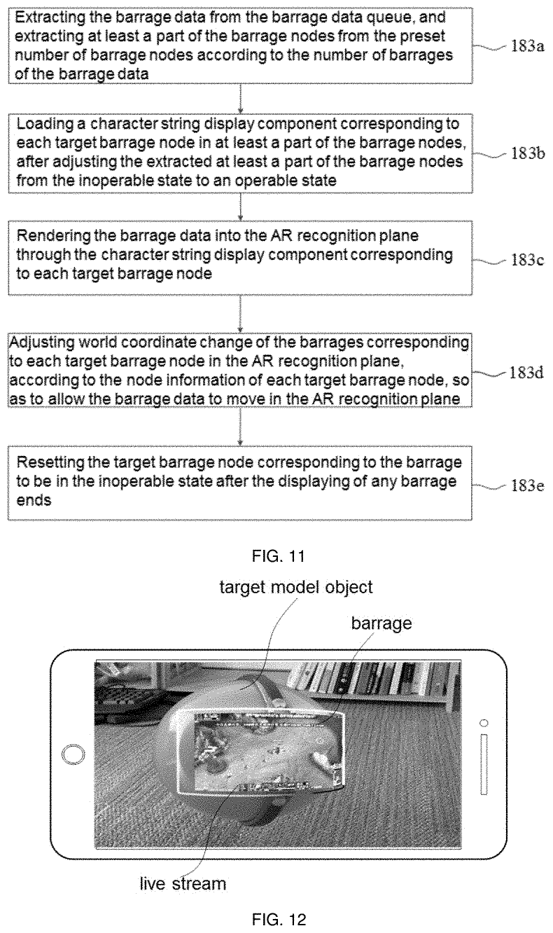

Thereafter, for Step 183, referring to FIG. 11, in some embodiments, Step 183 may be implemented by the following steps.

Step 183a, extracting the barrage data from the barrage data queue, and extracting at least a part of the barrage nodes from the preset number of barrage nodes according to the number of barrages of the barrage data.

Step 183b2, loading a character string display component corresponding to each target barrage node in at least a part of the barrage nodes, after adjusting the extracted at least a part of the barrage nodes from the inoperable state to an operable state.

Step 183c, rendering the barrage data into the AR recognition plane through the character string display component corresponding to each target barrage node.

Step 183d, adjusting world coordinate change of the barrages corresponding to each target barrage node in the AR recognition plane, according to the node information of each target barrage node, so as to allow the barrage data to move in the AR recognition plane.

Step 183e, resetting the target barrage node corresponding to the barrage to be in the inoperable state, after the display of any barrage ends.

In some implementations of the embodiments of the present disclosure, for Step 183a, the live streaming watching terminal 200 may determine the number of extracted barrage nodes according to the number of barrages in the extracted barrage data. For example, assuming that the number of barrages is 10, the live streaming watching terminal 200 may extract 10 target barrage nodes as display nodes of the 10 barrages.

Next, for Step 183b, the live streaming watching terminal 200 can load the character string display components corresponding to the 10 target barrage nodes after adjusting the extracted 10 target barrage nodes from the inoperable state to the operable state. In the above, the character string display component may serve as an image component configured to display a character string on the live streaming watching terminal 200, and taking the live streaming watching terminal 200 running on the Android system as an example, the character string display component may be TextView.

Optionally, in some embodiments, before executing Step 183b, the corresponding relationship between each barrage node and the character string display component may be pre-set. In this way, after the target barrage node is determined, a corresponding character string display component configured to display the barrage can be acquired. Thus, the barrage data can be rendered into the AR recognition plane through the character string display component corresponding to each target barrage node.

In the above exemplary embodiments provided by the embodiments of the present disclosure, the live streaming watching terminal 200 may rewrite a coordinate updating method in the barrage node, and the coordinate updating method may be executed once every preset time period (for example, 16 ms). In this way, the live streaming watching terminal 200 can update the world coordinates of each barrage according to the display information set above. For example, the live streaming watching terminal 200 may start to display the barrages at a position offset from a first direction of the parent node by a preset unit of displacement on the X axis, and then update the world coordinates of the preset displacement in each preset time period until the updated world coordinates are world coordinates at a position offset from a second direction of the parent node by a preset unit of displacement, and the display of the barrage ends. Thereafter, the live streaming watching terminal 200 may reset the target barrage node corresponding to the barrage to be in the inoperable state.

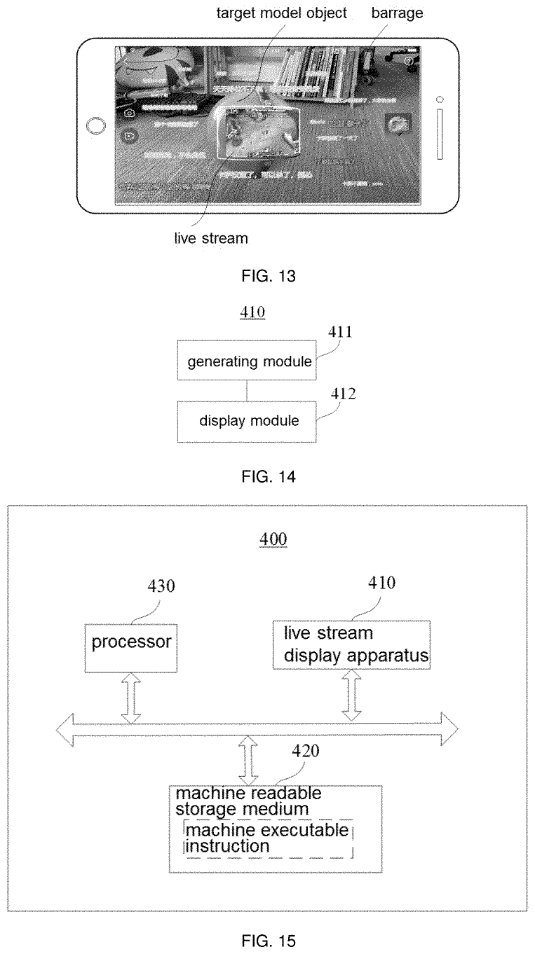

For the convenience of displaying the scenario of the embodiments of the present disclosure, brief description is made below with reference to FIG. 12 and FIG. 13, schematic views of displaying the barrages in the live stream and displaying the barrages in the AR recognition plane respectively provided in the present disclosure.

Referring to FIG. 12, a schematic view of an interface of an exemplary AR recognition plane entered by the live streaming watching terminal 200 after turning on a camera is shown, wherein the target model object shown in FIG. 12 may be adaptively set in a certain position in a real-world scenario, for example, in a middle position, and in this case, the live stream can be rendered onto, for example, the target model object shown in FIG. 12 for displaying in the foregoing embodiment, and at this time, it can be seen that the live stream has been rendered into the target model object shown in FIG. 12. In this solution, it can be seen that the barrages are displayed in the live stream on the target model object.

Referring to FIG. 13, a schematic view of an interface of an exemplary AR recognition plane entered by the live streaming watching terminal 200 after turning on a camera is shown, the barrages can be rendered into the AR recognition plane according to the foregoing embodiments, and in this case, it can be seen that the barrages are displayed in the AR-rendered real-world scenarios, but not in the live stream.

Thus, for the audience, the display of the barrages in the AR-rendered real-world scenarios can be realized, and the audience can see, after switching on the camera, the barrages moving in the real-world scenario, thus enhancing the realistic experience of the barrage display, and improving the live streaming playability.

Based on the same inventive concept as the above live stream display method provided by the embodiment of the present disclosure, referring to FIG. 14, it shows a schematic view of functional modules of a live stream display apparatus 410 provided in an embodiment of the present disclosure. In some embodiments, the live stream display apparatus 410 may be divided into functional modules according to the above method embodiments. For example, various functional modules may be divided according to various corresponding functions, or two or more functions may be integrated into one processing module. The integrated module above may be implemented in the form of hardware, or in the form of a software functional module.

It should be noted that the division of the modules in the embodiments of the present disclosure is schematic, and is merely a logical function division, and there may be another dividing manner in actual implementation. For example, in a case where various functional modules are divided according to various corresponding functions, the live stream display apparatus 410 shown in FIG. 14 is only a schematic view of apparatus. In the above, the live stream display apparatus 410 may include a generating module 411 and a display module 412, and the functions of various functional modules of the live stream display apparatus 410 are exemplarily set forth below.

The generating module 411 may be configured to enter, upon detecting an AR display instruction, an AR recognition plane and generate a corresponding target model object in the AR recognition plane. It may be understood that the generating module 411 may be configured to perform the above Step 110, and for some implementation manners of the generating module 411, reference may be made to the contents described above with respect to Step 110.

The display module 412 may be configured to render the received live stream onto the target model object, so as to display the live stream on the target model object. It may be understood that the display module 412 may be configured to perform the above Step 120, and for some implementation manners of the display module 412, reference may be made to the contents described above with respect to the above Step 120.

Optionally, in some possible embodiments, the generating module 411, when entering the AR recognition plane and generating a corresponding target model object in the AR recognition plane, may be configured to:

determine a to-be-generated target model object according to an AR display instruction upon detecting the AR display instruction;

load a model file of the target model object so as to obtain the target model object;

enter the AR recognition plane, and judge a tracking state of the AR recognition plane; and

generate a corresponding target model object in the AR recognition plane when the tracking state of the AR recognition plane is an online tracking state.

Optionally, in some possible embodiments, the generating module 411, when loading the model file of the target model object so as to obtain the target model object, may be configured to:

import a three-dimensional model of a target model object by using a preset model import plug-in to obtain an sfb format file corresponding to the target model object; and load the sfb format file through a preset rendering model to obtain the target model object.

Optionally, in some possible embodiments, the generating module 411, when generating a corresponding target model object in the AR recognition plane, may be configured to:

create an anchor point on a preset point of the AR recognition plane, so as to fix the target model object on the preset point through the anchor point;

create a corresponding display node at the position of the anchor point, and create a first child node inherited to the display node, so as to adjust and display the target model object through the first child node; and

create a second child node inherited to the first child node, so that the second child node is replaced by a skeleton adjustment node upon detecting an adding request of the skeleton adjustment node, wherein the skeleton adjustment node is set to adjust the skeleton point of the target model object.

Optionally, in some possible embodiments, the generating module 411, when displaying the target model object in the AR recognition plane through the first child node, may be configured to:

invoke a binding setting method of the first child node, and bind the target model object to the first child node, so as to complete the displaying of the target model object in the AR recognition plane.

Optionally, in some possible embodiments, the manner of adjusting the target model object through the first child node may include one or a combination of more of the following adjustment manners:

scaling the target model object;

translating the target model object; and

rotating the target model object.

Optionally, in some possible embodiments, the display module 412, when rendering the received live stream onto the target model object so as to display the live stream on the target model object, may be configured to:

invoke a software development kit SDK to pull the live stream from a live streaming server, and create an external texture of the live stream;

transmit the texture of the live stream to a decoder of the SDK for rendering; and

upon receiving a rendering start state of the decoder of the SDK, invoke an external texture setting method to render the external texture of the live stream onto the target model object, so as to display the live stream on the target model object.

Optionally, in some possible embodiments, the display module 412, when invoking an external texture setting method to render the external texture of the live stream onto the target model object, may be configured to:

traverse each region in the target model object, and determine at least one model rendering region in the target model object that can render the live stream; and

invoke an external texture setting method to render the external texture of the live stream onto at least one model rendering region.

Optionally, in some possible embodiments, the generating module 411 is further configured to monitor each frame of AR stream data in the AR recognition plane;

determine a corresponding trackable AR augmented object in the AR recognition plane, upon monitoring that the image information in the AR stream data matches a preset image in a preset image database.

The display module 412 is further configured to render the target model object into the trackable AR augmented object.

Optionally, in some possible embodiments, the generating module 411 is further configured to set the preset image database in an AR software platform program configured to switch on the AR recognition plane, so that the AR software platform program makes, when switching on the AR recognition plane, the image information in the AR stream data matched with a preset image in the preset image database.

Optionally, in some possible embodiments, the generating module 411, after determining the corresponding trackable AR augmented object in the AR recognition plane upon monitoring that the image information in the AR stream data matches a preset image in a preset image database, is further configured to:

acquire from the AR stream data an image capturing component configured to capture image data;

detect whether the tracking state of the image capturing component is an online tracking state; and

monitor whether the image information in the AR stream data matches a preset image in a preset image database upon detecting that the tracking state of the image capturing component is the online tracking state.

Optionally, in some possible embodiments, the generating module 411, after determining the corresponding trackable AR augmented object in the AR recognition plane, is further configured to:

detect a tracking state of the trackable AR augmented object; and

the display module 412 renders the target model object into the trackable AR augmented object upon detecting that the tracking state of the trackable AR augmented object is an online tracking state.

Optionally, in some possible embodiments, the display module 412, when rendering the target model object into the trackable AR augmented object, may be configured to:

acquire, by a decoder, first size information of a live stream rendered in the target model object, and acquire second size information of the trackable AR augmented object; and

adjust a display node according to a proportional relationship between the first size information and the second size information, so as to adjust a proportion of the target model object in the trackable AR augmented object, wherein the display node is set to adjust the target model object.

Optionally, in some possible embodiments, the display module 412 is further configured to:

render the barrage data corresponding to the live stream into the AR recognition plane, so that the barrage data moves in the AR recognition plane.

Optionally, in some possible embodiments, the display module 412, when rendering the barrage data corresponding to the live stream into the AR recognition plane so that the barrage data moves in the AR recognition plane, may be configured to:

obtain barrage data corresponding to the live stream from the live streaming server, and add the barrage data to a barrage queue;

initially set node information of a preset number of barrage nodes, wherein a parent node of each barrage node is a second child node, and each barrage node is configured to display one barrage; and

extract the barrage data from the barrage queue to render the barrage data into the AR recognition plane through at least a part of barrage nodes in the preset number of barrage nodes, so that the barrage data moves in the AR recognition plane.

Optionally, in some possible embodiments, the display module 412, when adding the barrage data to the barrage queue, may be configured to:

judge whether the queue length of the barrage queue is greater than the number of barrages of the barrage data;

add the barrage data to the barrage queue when the queue length of the barrage queue is not greater than the number of barrages of the barrage data;

expand, when the queue length of the barrage queue is greater than the number of barrages of the barrage data, the length of the barrage queue by a preset length, and then continue to add the barrage data to the barrage queue, each time the queue length of barrage queue each time is greater than the number of barrages of the barrage data; and

discard a set number of barrages from the barrage queue in an order from early barrage time to late barrage time, when the queue length of the expanded barrage queue is greater than the preset threshold.

Optionally, in some possible embodiments, the display module 412, when initially setting a preset number of barrage nodes, may be configured to:

set a preset number of barrage nodes with the second child node as the parent node; and

set the display information of each barrage node in the AR recognition plane.

Optionally, in some possible embodiments, the AR recognition plane includes an X axis, a Y axis, and a Z axis with the second node as a coordinate central axis.

The display module 412, when setting the display information of each barrage node in the AR recognition plane, may be configured to:

set world coordinates of each barrage node in the AR recognition plane along different offset displacement points on the Y axis and the Z axis, so that various barrage nodes are arranged at intervals along the Y axis and the Z axis;

set a first position on the X axis as a world coordinate for starting to display each barrage node, and setting a second position on the X axis as a world coordinate for ending display of each barrage node, wherein the first position is a position offset by a preset unit of displacement from the first direction of the parent node on the X axis, and the second position is a position offset by a preset unit of displacement from the second direction of the parent node on the X axis.

Optionally, in some possible embodiments, before the display module 412 extracts the barrage data from the barrage queue to render the barrage data into the AR recognition plane through at least a part of barrage nodes in a preset number of barrage nodes so that the barrage data moves in the AR recognition plane, the display module 412 is further configured to:

set the preset number of barrage nodes to be in an inoperable state.

The display module 412, when extracting the barrage data from the barrage queue to render the barrage data into the AR recognition plane through at least a part of barrage nodes in a preset number of barrage nodes so that the barrage data moves in the AR recognition plane, may be configured to:

extract the barrage data from the barrage data queue, and extract at least a part of the barrage nodes from the preset number of barrage nodes according to the number of barrages of the barrage data;

load a character string display component corresponding to each target barrage node in at least a part of the barrage nodes, after adjusting the extracted at least a part of the barrage nodes from the inoperable state to an operable state;

render the barrage data into the AR recognition plane through the character string display component corresponding to each target barrage node;

adjust world coordinate change of the barrages corresponding to each target barrage node in the AR recognition plane according to the node information of each target barrage node, so as to allow the barrage data to move in the AR recognition plane; and

reset, after the display of any barrage ends, the target barrage node corresponding to the barrage to be in the inoperable state.

Based on the same inventive concept as the above live stream display method provided by the embodiments of the present disclosure, referring to FIG. 15, it shows a structural schematic block diagram of an electronic device 400 configured to execute the above live stream display method provided in an embodiment of the present disclosure. The electronic device 400 may be the live streaming providing terminal 200 shown in FIG. 1, or when the anchor of the live streaming providing terminal 300 serves as an audience, the electronic device 400 may also be the live streaming providing terminal 300 shown in FIG. 1. As shown in FIG. 15, the electronic device 400 may include a live stream display apparatus 410, a machine readable storage medium 420, and a processor 430.

In some implementations of the embodiments of the present disclosure, the machine readable storage medium 420 and the processor 430 may be both located in the electronic device 400 and disposed separately from each other.

However, it should be understood that in some other implementations of the embodiments of the present disclosure, the machine readable storage medium 420 may also be independent of the electronic device 400, and may be accessed by the processor 430 through a bus interface. Alternatively, the machine readable storage medium 420 may also be integrated into the processor 430, for example, may be a cache and/or a general purpose register.

The processor 430 may be a control center of the electronic device 400, and various parts of the whole electronic device 400 are connected by various interfaces and lines. By running or executing software program and/or module stored in the machine readable storage medium 420, and invoking data stored in the machine readable storage medium 420, various functions and processing data of the electronic device 400 are executed, thereby monitoring the electronic device 400 as a whole.

Optionally, the processor 430 may include one or more processing cores; for example, the processor 430 may be integrated with an application processor and a modem processor, wherein the application processor mainly processes an operating system, a user interface, an application, and so on, and the modem processor mainly processes wireless communication. It may be understood that the above modem processor also may not be integrated into a processor.

In the above, the processor 430 may be an integrated circuit chip, with a signal processing ability. In some implementations, various steps of the above method embodiments may be completed by an integrated logic circuit of hardware or instruction in a software form in the processor 430. The above processor 430 may be a general purpose processor, a digital signal processor (DSP), an application specific integrated circuit (ASIC), a field programmable gate array (FPGA) or other programmable logic devices, discrete gates, transistor logic devices, or discrete hardware components that can realize or implement various methods, steps, and logic blocks disclosed in the embodiments of the present disclosure. The general purpose processor may be a microprocessor or the processor also may be any conventional processor and so on. The steps in the method disclosed in the embodiments of the present disclosure may be directly carried out and completed by hardware decoding processor, or carried out and completed by hardware and software modules in the decoding processor.

The machine readable storage medium 420 may be ROM or other types of static storage devices that can store static information and instructions, RAM or other types of dynamic storage devices that can store information and instructions, or may be an electrically erasable programmable-only memory (EEPROM), compact disc read-only memory (CD-ROM) or other optical disk storage, optical disc storage (including compact discs, laser discs, optical discs, digital universal discs, Blu-ray discs, etc.), a magnetic disk storage medium or other magnetic storage device, or any other medium that can be configured to carry or store desired program codes in the form of instructions or data structures and that can be accessed by a computer, but is not limited thereto. The machine readable storage medium 420 may exist independently, and is connected to the processor 430 through a communication bus. The machine readable storage medium 420 may also be integrated with the processor. In the above, the machine readable storage medium 420 may be configured to store machine executable instructions for executing the solution of the present disclosure. The processor 430 may be configured to execute machine executable instructions stored in the machine readable storage medium 420, so as to implement the live stream display method provided in the foregoing method embodiments.

The live stream display apparatus 410 may include, for example, various functional modules (for example, the generating module 411 and the display module 412) described in FIG. 14, and may be stored in the form of a software program code in a machine readable storage medium 420, and the processor 430 may realize the live stream display method provided by the foregoing method embodiments by executing various functional modules of the live stream display apparatus 410.

As the electronic device 400 provided by the embodiments of the present disclosure is another implementation form of the method embodiments executed by the above electronic device 400, and the electronic device 400 may be configured to execute the live stream display method provided by the foregoing method embodiments, reference may be made to the foregoing method embodiments for the technical effects that can be obtained thereby, which is not repeated herein.

Further, an embodiment of the present disclosure further provides a readable storage medium containing computer executable instructions, and when executed, the computer executable instructions may be configured to realize the live stream display method provided by the foregoing method embodiments.

Certainly, for the storage medium including computer executable instructions provided in the embodiments of the present disclosure, the computer executable instructions thereof are not limited to the above method operations, and related operations in the live stream display method provided by any embodiment of the present disclosure may also be executed.

In the above exemplary embodiments provided by the present disclosure, all or part may be realized by software, hardware, firmware, or any combination thereof. When realized using software, it may be realized in whole or in part in the form of a computer program product. The computer program product may include one or more computer instructions. When the computer program instructions are loaded and executed on the computer, the flow or function according to the embodiments of the present disclosure may be generated in whole or in part. The computer may be a general purpose computer, a special purpose computer, a computer network, or other programmable apparatus. The computer instructions may be stored in a computer readable storage medium or transmitted from one computer readable storage medium to another computer readable storage medium, for example, the computer instructions may be transmitted from one website site, computer, server or data center to another website site, computer, server or data center in a wired (e.g., coaxial cable, fiber optic, digital subscriber line (DSL)) or wireless (e.g., infrared, wireless, microwave, etc.) manner. The computer readable storage medium may be any available medium that can be accessed by a computer or a data storage device, such as integrated server and data center including one or more available media. The available media may be magnetic media (e.g., floppy disk, hard disk, magnetic tape), optical media (e.g., DVD), or semiconductor media (e.g., solid state disk (SSD)), etc.

The embodiments of the present disclosure are described with reference to the flowcharts and/or block diagrams of the method, device (system) and a computer program product in the embodiments of the present disclosure. It should be understood that each flow and/or block in the flowchart and/or block diagram, and a combination of the flows and/or the blocks in the flowchart and/or block diagram can be implemented by computer program instructions.

These computer program instructions can be provided in a general purpose computer, a specific computer, an embedded processor or a processor of other programmable data processing device so as to produce a machine, such that an apparatus configured to realize a function designated in one or more flows in the flowchart and/or one or more blocks in the block diagram is produced through instructions executed by the processor of the computer or other programmable data processing devices.

These computer program instructions also may be stored in a computer readable memory capable of directing the computer or other programmable data processing devices to work in a specific manner, such that instructions stored in the computer readable memory produce a manufactured product including an instruction apparatus, which instruction apparatus realizes the function designated in one or more flows of the flowchart and/or one or more blocks of the block diagram.

These computer program instructions may also be loaded into computers or other programmable data processing devices, such that a sequence of operational steps are performed on computers or other programmable devices to produce a computer-implemented process, in this way, instructions executed on the computers or other programmable devices provide steps for realizing the functions designated in one or more flows of a flowchart and/or in one or more blocks of a block diagram.

Apparently, those skilled in the art could make various modifications or variations on the embodiments of the present disclosure without departing from the spirit and scope of the present disclosure. In this way, if these modifications and variations of the embodiments of the present disclosure fall within the scope of the claims of the present disclosure or equivalent technologies thereof, these modifications and variations are also intended to be covered by the present disclosure.

Finally, it should be noted that the above-mentioned are merely part of the embodiments of the present disclosure, rather than being intended to limit the present disclosure. While the detailed description is made to the present disclosure with reference to the preceding embodiments, for those skilled in the art, they still could modify the technical solutions recited in various preceding embodiments, or make equivalent substitutions to some of the technical features therein. Any modifications, equivalent substitutions, improvements and so on, within the spirit and principle of the present disclosure, should be covered within the scope of protection of the present disclosure.

### INDUSTRIAL APPLICABILITY

In the present disclosure, upon detecting an AR display instruction, an AR recognition plane is entered and a corresponding target model object is generated in the AR recognition plane, then the received live stream is rendered onto the target model object, so as to display the live stream on the target model object. In this way, the application of the Internet live stream in the AR-rendered real-world scenario can be realized, and the audience can watch the Internet live stream on the target model object rendered in the real-world scenario, thereby improving the live streaming playability.

Moreover, each frame of AR stream data is monitored in the AR recognition plane, and upon monitoring that the image information in the AR stream data matches a preset image in the preset image database, a corresponding trackable AR augmented object is determined in the AR recognition plane; then the target model object is rendered into the trackable AR augmented object. In this way, the application of the trackable AR augmented object in the live stream can be realized, so that the interaction between the audience and the anchor is closer to the real-world scenario experience.

Furthermore, the barrage data corresponding to the live stream is rendered into the AR recognition plane, so as to move the barrage data in the AR recognition plane. In this way, the display of the barrages in the AR-rendered real-world scenario can be realized, and after switching on the camera, the audience can see the barrages moving in the AR-rendered real-world scenario, thereby enhancing the realistic experience of the barrage display, and improving the live streaming playability.

1. A live stream display method, applicable to a live streaming watching terminal, wherein the method comprises steps of:
entering, upon detecting an augmented reality (AR) display instruction, an AR recognition plane and generating a corresponding target model object in the AR recognition plane; and
rendering a received live stream onto the target model object, so as to display the live stream on the target model object.

2. The live stream display method according to claim 1, wherein the step of entering upon detecting an augmented reality (AR) display instruction an AR recognition plane and generating a corresponding target model object in the AR recognition plane comprises:
determining a to-be-generated target model object according to the AR display instruction upon detecting the AR display instruction;
loading a model file of the target model object so as to obtain the target model object;
entering the AR recognition plane, and judging a tracking state of the AR recognition plane; and
generating the corresponding target model object in the AR recognition plane when the tracking state of the AR recognition plane is an online tracking state.

3. The live stream display method according to claim 2, wherein the step of loading a model file of the target model object so as to obtain the target model object comprises:
importing a three-dimensional model of the target model object by using a preset model import plug-in, to obtain an sfb format file corresponding to the target model object, and
loading the sfb format file through a preset rendering model to obtain the target model object.

4. The live stream display method according to claim 2, wherein the step of generating the corresponding target model object in the AR recognition plane comprises:
creating an anchor point on a preset point of the AR recognition plane, so as to fix the target model object on the preset point through the anchor point;
creating a corresponding display node at a position of the anchor point, and creating a first child node inherited to the display node, so as to adjust and display the target model object in the AR recognition plane through the first child node; and
creating a second child node inherited to the first child node, so that the second child node is replaced by a skeleton adjustment node upon detecting an adding request of the skeleton adjustment node, wherein the skeleton adjustment node is configured to adjust at least one skeleton point of the target model object.

5. The live stream display method according to claim 4, wherein the step of displaying the target model object in the AR recognition plane through the first child node comprises:
invoking a binding setting method of the first child node, and binding the target model object to the first child node, so as to complete the displaying of the target model object in the AR recognition plane.

6. (canceled)

7. The live stream display method according to claim 1, wherein the step of rendering a received live stream onto the target model object so as to display the live stream on the target model object comprises:
invoking a software development kit (SDK) to pull the live stream from a live streaming server, and creating an external texture of the live stream;
transmitting the texture of the live stream to a decoder of the SDK for rendering; and
invoking, upon receiving a rendering start state of the decoder of the SDK, an external texture setting method to render the external texture of the live stream onto the target model object, so as to display the live stream on the target model object.

8. The live stream display method according to claim 7, wherein the step of invoking an external texture setting method to render the external texture of the live stream onto the target model object comprises:
traversing each region in the target model object, and determining at least one model rendering region in the target model object that can be used to render the live stream; and
invoking the external texture setting method to render the external texture of the live stream onto the at least one model rendering region.

9. The live stream display method according to claim 1, wherein the method further comprises:
monitoring each frame of AR stream data in the AR recognition plane;
determining a corresponding trackable AR augmented object in the AR recognition plane, upon monitoring that image information in the AR stream data matches a preset image in a preset image database; and
rendering the target model object into the trackable AR augmented object.

10. The live stream display method according to claim 9, wherein the method further comprises:
setting the preset image database in an AR software platform program configured to switch on the AR recognition plane, so that the AR software platform program makes, when switching on the AR recognition plane, the image information in the AR stream data matched with the preset image in the preset image database.

11. The live stream display method according to claim 9, wherein after the step of determining a corresponding trackable AR augmented object in the AR recognition plane upon monitoring that image information in the AR stream data matches a preset image in a preset image database, the method further comprises:
acquiring an image capturing component configured to capture image data from the AR stream data;
detecting whether a tracking state of the image capturing component is an online tracking state; and
monitoring whether the image information in the AR stream data matches the preset image in a preset image database upon detecting that the tracking state of the image capturing component is the online tracking state.

12. The live stream display method according to claim 9, wherein after the step of determining a corresponding trackable AR augmented object in the AR recognition plane, the method further comprises:
detecting a tracking state of the trackable AR augmented object; and
executing, upon detecting that the tracking state of the trackable AR augmented object is an online tracking state, the step of rendering the target model object into the trackable AR augmented object.

13. The live stream display method according to claim 9, wherein the step of rendering the target model object into the trackable AR augmented object comprises:
acquiring, by a decoder, first size information of a live stream rendered in the target model object, and acquiring second size information of the trackable AR augmented object; and
adjusting the display node according to a proportional relationship between the first size information and the second size information, so as to adjust a proportion of the target model object in the trackable AR augmented object, wherein the display node is configured to adjust the target model object.

14. The live stream display method according to claim 4, wherein the method further comprises:
rendering barrage data corresponding to the live stream into the AR recognition plane, so that the barrage data moves in the AR recognition plane.

15. The live stream display method according to claim 14, wherein the step of rendering barrage data corresponding to the live stream into the AR recognition plane so that the barrage data moves in the AR recognition plane comprises:
obtaining from the live streaming server the barrage data corresponding to the live stream, and adding the barrage data to a barrage queue;
initially setting node information of a preset number of barrage nodes, wherein a parent node of each barrage node is the second child node, and each barrage node is configured to display one barrage; and
extracting the barrage data from the barrage queue to render the barrage data into the AR recognition plane through at least a part of barrage nodes in the preset number of barrage nodes, so that the barrage data moves in the AR recognition plane.

16. The live stream display method according to claim 15, wherein the step of adding the barrage data to a barrage queue comprises:
judging whether the queue length of the barrage queue is greater than number of barrages of the barrage data;
adding the barrage data to the barrage queue when a queue length of the barrage queue is not greater than the number of barrages of the barrage data;
expanding, when the queue length of the barrage queue is greater than the number of barrages of the barrage data, the length of the barrage queue by a preset length and then continuing to add the barrage data to the barrage queue, each time the queue length of the barrage queue each time is greater than the number of barrages of the barrage data; and
discarding a set number of barrages from the barrage queue in an order from early barrage time to late barrage time, when a queue length of the expanded barrage queue is greater than a preset threshold.

17. The live stream display method according to claim 15, wherein the step of initially setting a preset number of barrage nodes comprises:
setting the preset number of barrage nodes with the second child node as the parent node; and
setting the display information of each barrage node in the AR recognition plane, respectively.

18. The live stream display method according to claim 17, wherein the AR recognition plane comprises an X axis, a Y axis, and a Z axis with the second node as a coordinate central axis;
the step of setting the display information of each barrage node in the AR recognition plane comprises:
setting world coordinates of each barrage node in the AR recognition plane along different offset displacement points on the Y axis and the Z axis, so that various barrage nodes are arranged at intervals along the Y axis and the Z axis;
setting a first position on the X axis as a world coordinate for starting to display each barrage node, and setting a second position on the X axis as a world coordinate for ending displaying of the each barrage node, wherein the first position is a position offset by a preset unit of displacement from a first direction of the parent node on the X axis, and the second position is a position offset by a preset unit of displacement from a second direction of the parent node on the X axis.

19. The live stream display method according to claim 15, wherein before the step of extracting the barrage data from the barrage queue to render the barrage data into the AR recognition plane through at least a part of barrage nodes in the preset number of barrage nodes so that the barrage data moves in the AR recognition plane, the method further comprises:
setting the preset number of barrage nodes to be in an inoperable state;
the step of extracting the barrage data from the barrage queue to render the barrage data into the AR recognition plane through at least a part of barrage nodes in the preset number of barrage nodes so that the barrage data moves in the AR recognition plane comprises:
extracting the barrage data from the barrage data queue, and extracting at least a part of the barrage nodes from the preset number of barrage nodes according to the number of barrages of the barrage data;
loading a character string display component corresponding to each target barrage node in the at least a part of the barrage nodes, after adjusting the extracted at least a part of the barrage nodes from the inoperable state to an operable state;
rendering the barrage data into the AR recognition plane through the character string display component corresponding to the each target barrage node;
adjusting world coordinate change of the barrages corresponding to the each target barrage node in the AR recognition plane, according to the node information of the each target barrage node, so as to allow the barrage data to move in the AR recognition plane; and
resetting the target barrage node corresponding to the barrage to be in the inoperable state after the displaying of any barrage ends.

20. A live stream display apparatus, applicable to a live streaming watching terminal, wherein the apparatus comprises:
a generating module, configured to enter, upon detecting an AR display instruction, an AR recognition plane and generate a corresponding target model object in the AR recognition plane; and
a display module, configured to render a received live stream onto the target model object, so as to display the live stream on the target model object.

21. An electronic device, wherein the electronic device comprises a machine readable storage medium and a processor, the machine readable storage medium stores machine executable instructions, and when the processor executes the machine executable instructions, the electronic device implements the live stream display method according to claim 1.

22. (canceled)
